(19) United States
(12) Patent Application Publication
(10) Pub. No.: US 2019/0048296 A1
(43) Pub. Date: Feb. 14, 2019

(54) UNIT DOSE DETERGENT PRODUCTS WITH IMPROVED PAC RIGIDITY

(71) Applicant: Henkel IP & Holding GmbH, Duesseldorf (DE)

(72) Inventor: Daniel Thomas Pirokowski, Fairfield, CT (US)

(73) Assignee: Henkel IP & Holding GmbH, Duesseldorf (DE)

(21) Appl. No.: 15/673,590

(22) Filed: Aug. 10, 2017

(51) Int. Cl. C11D 17/04; C11D 3/20; C11D 3/43; C11D 1/83

(52) U.S. Cl. CPC C11D 17/043; C11D 3/2089; C11D 1/72; C11D 1/83; C11D 3/43

(57) ABSTRACT

The present invention provides stable unit dose compositions with enhanced pack rigidity. Such unit dose compositions comprise water, at least one non-aqueous solvent, an ethoxylated fatty acid, a beneficial composition, and a water-soluble container formed from a water-soluble or water-dispersible film material.

### FIELD OF THE INVENTION

The present invention is in the fields of household and industrial cleaning. More particularly, the invention relates to stable unit dose detergent compositions with enhanced pack rigidity.

### BACKGROUND OF THE INVENTION

Unit dose (also called single dose) detergent products are often found by some consumers to be preferable for use in automatic dishwashing and laundry applications. Unit dose products have several advantages, including convenience of use and dispensing, lower cost per use, and avoiding or minimizing skin contact with potentially irritating cleaning compositions.

Unit dose detergent products often employs polyvinyl alcohol (PVOH) or polyvinyl acetate (PVA) films to form a sealed container (pac or pack), optionally with multi-compartments, for storing detergent compositions. Traditional single dose formulations employ a total of three solvents. Most commonly used solvent system includes water, glycerin, and glycols. Glycerin and glycols (e.g., propylene glycol) are non-aqueous solvents, which are used in an amount sufficient to bind water, solvate materials, and fill volume within the detergent pack. High solvent content also ensures unit dose detergent products substantially free of efflorescence. Efflorescence is a phenomenon when solvated salts precipitate out, on, or in the film.

However, when unit dose formulations have a high solvent content, e.g., over 30% wt of total solvents based on the weight of the entire formulation, it is difficult to maintain the rigidity of unit dose products (pac rigidity). The problem is more evident when the unit dose products have multi-chambers and when only one chamber contains such high solvent content composition. With increased solvent content, the weight of the composition in the compartment of multi-chamber product makes it ‘sag’ down against other chambers, making the unit dose composition appear ‘floppy’. Moreover, such unit dose products may suffer from unexpected rupturing. This is because the weight of the compartment puts undue load pressure on the film causing it to overstretch and rupture, which may lead to leakage or breakage.

Therefore, there is a need in the art for a unit dose product having a high solvent content while maintaining pack integrity such as rigidity and stability. It is desirable that such unit dose product can withstand typical shipping and handling, and is less prone to leakage or breakage, while maintaining the level of cleaning performance. Other desirable features and characteristics of the unit dose product in accordance with the present invention will become apparent from the subsequent detailed description of the invention and the appended claims.

### SUMMARY OF THE INVENTION

In one aspect, the present invention is directed to a unit dose product which comprises a container formed from a water-soluble or water-dispersible film material and a liquid composition being entrapped in the container. The liquid composition comprises a solvent system, an ethoxylated fatty acid, and a beneficial composition. The solvent system includes water and at least one non-aqueous solvent. The solvent system totals from about 15% to about 75%, preferably from about 25% to about 70%, and more preferably from about 30% to about 65%, by weight of the liquid composition. In some embodiments, the solvent system totals from about 20% to about 55% by weight of the liquid composition.

The water-soluble or water-dispersible film material may be selected from the group consisting of polyvinyl alcohol (PVOH), polyvinyl acetate (PVA), film forming cellulosic polymer, polyacrylic acid, polyacrylamide, polyanhydride, polysaccharide, polyvinyl pyrrolidone, polyalkylene oxide, cellulose, cellulose ether, cellulose ester, cellulose amide, polyvinyl acetate, polycarboxylic acid and salt, polyaminoacid, polyamide, natural gums, polyacrylate, water-soluble acrylate copolymer, methylcellulose, carboxymethylcellulose sodium, dextrin, ethylcellulose, hydroxyethyl cellulose, maltodextrin, polymethacrylate, polyvinyl alcohol copolymer, and hydroxypropyl methyl cellulose (HPMC), and a mixture thereof. In preferred embodiments, the water-soluble or water-dispersible film material is selected from polyvinyl alcohol or polyvinyl acetate.

Suitable non-aqueous solvents for the solvent system may include polyols, ionic liquids, glycol ethers, EO/PO block copolymers, polyethylene glycol, and mixtures thereof, which are miscible with water, in particularly in the presence of surfactants. In some embodiments, the non-aqueous solvents are those having hydroxyl functional groups, such as propylene glycol, 2-methyl 1,3-propanediol, 1,3-propanediol, 1,5-pentanediol, glycerin, hexylene glycol, and/or a polymer or copolymer having a hydroxyl group. In preferred embodiments, the non-aqueous solvents comprise propylene glycol and glycerin. In other preferred embodiments, the non-aqueous solvents further include a low Mw polyethylene glycol.

It has been discovered by the inventors of the present application that inclusion of an ethoxylated fatty acid in the solvent system as described above surprisingly stabilizes the unit dose product and enhances the pack rigidity to an acceptable level, even when the liquid formulation has a high solvent content. Such formulations also provide comparable cleaning effects. The unit dose pack is less prone to leakage or breakage, and is more aesthetically pleasing. The ethoxylated fatty acid may be present in an amount of about 2% to about 40%, preferably from about 5% to about 20%, more preferably from about 8% to about 18%, by weight of the liquid composition. Ethoxylated fatty acid is a product from a fatty acid or a fatty acid salt reacted with a compound having a hydroxyethyl functional group.

Fatty acids suitable for preparing the ethoxylated fatty acid include carboxylic acids with a long aliphatic tail having a total of 8 to 25 carbons, preferably 11 to 20 carbons, more preferably, 12 to 18 carbons, and even more preferably from 14 to 18 carbons. The fatty acid can be saturated, monounsaturated, di-unsaturated, or poly-unsaturated fatty acids. In some embodiments, the fatty acid is hexanoic acid, heptanoic acid, octanoic acid, nonanoic acid, capric acid, undecanoic acid, dodecanoic acid (lauric acid), tridecanoic acid, myristic acid, pentadecanoic acid, palmitic acid, heptadecanoic acid, stearic acid, nonadecanoic acid, eicosanoic acid, heneicosanoic acid, docosanoic acid, myristoleic acid, palmitoleic acid, sapienic acid, oleic acid, elaidic acid, vaccenic acid, linoleic acid, linoelaidic acid, arachidonic acid, eicosapentaenoic acid, erucic acid, docosahexaenoic acid, or a mixture thereof. In other embodiments, the fatty acid is selected from the group consisting of arachidic acid, arachidonic acid, lauric acid, decanoic acid, caprylic acid, myristic acid, palmitic acid, palmitoleic acid, stearic acid, oleic acid, linoleic acid, and mixtures thereof. In a preferred embodiment, the fatty acid is stearic acid or lauric acid. In another preferred embodiment, the fatty acid is stearic acid.

The compound suitable for preparing the ethoxylated fatty acid may be a linear or branched alcohol wherein a hydroxyl group is connected to an ethylene group. Diols with two hydroxyl groups attached to separate carbon atoms in an aliphatic chain may also be used, as long as at least one of the hydroxyl groups is connected to an ethylene group. Polyols, such as polyethylene glycol, or copolymers, such as EO/PO, may also be suitable to prepare the ethoxylated fatty acid, as long as the polymers or copolymers provide an ethoxyl functional group functional group. A preferred polyol is PEG. According to a preferred embodiment, the ethoxylated fatty acid is PEG stearate, fatty methyl ester ethoxylate, or PEG laurate. A preferred fatty methyl ester ethoxylate is C18 methyl ester ethoxylate 10EO. The beneficial composition may include a surfactant system, a fragrance composition, a color care agent, a soil releasing polymer, an anti-disposition agent, a softening agent, or a combination thereof.

The surfactant system may comprise an anionic surfactant, a nonionic surfactant, a cationic surfactant, an ampholytic surfactant, a zwitterionic surfactant, or a mixture thereof. In some embodiments, the surfactant system comprises (a) an alcohol ethoxylsulfate (AES), and (b) an alcohol ethoxylate (AE). In other embodiments, the surfactant system does not contain a sulfate surfactant.

In a second aspect, the present invention is directed to a liquid formulation comprising a solvent system, an ethoxylated fatty acid, and a surfactant system, wherein solvent system totals from about 15% to about 75%, preferably from about 25% to about 70%, and more preferably from about 30% to about 65%, by weight of the liquid formulation. The liquid formulation is suitable for use in a unit dose detergent product or in a conventional bulk supply detergent product.

According to some embodiments of the second aspect of the invention, the solvent system of the liquid formulation includes water and at least one non-aqueous solvent. In preferred embodiments, the solvent system comprises water, glycerin, and propylene glycol. In even preferred embodiments, the solvent system further comprises a polymeric solvent (e.g., polyethylene glycol) in addition to water, glycerin, and propylene glycol.

The ethoxylated fatty acid is an ester derived from a fatty acid and a hydroxyethyl compound. The fatty acid may be selected from the group consisting of arachidic acid, arachidonic acid, lauric acid, decanoic acid, caprylic acid, myristic acid, palmitic acid, palmitoleic acid, stearic acid, oleic acid, linoleic acid, and mixtures thereof. The hydroxyethyl compound is a linear or branched alcohol wherein a hydroxyl group is connected to an ethylene group. The hydroxyethyl compound may be a small molecule compound (e.g., a diol) or a polymeric compound (e.g., a polyol or block copolymer, wherein one end monomer unit has a hydroxyethyl functional group).

According to some embodiments, the ethoxylated fatty acid is PEG stearate, fatty methyl ester ethoxylate, or PEG laurate. According to preferred embodiments, the ethoxylated fatty acid is PEG stearate. The ethoxylated fatty acid may be present in an amount of about 2% to about 40%, preferably from about 5% to about 20%, more preferably from about 8% to about 18%, by weight of the liquid composition.

The surfactant system may comprise an anionic surfactant, a nonionic surfactant, a cationic surfactant, an ampholytic surfactant, a zwitterionic surfactant, or a mixture thereof. In some embodiments, the surfactant system comprises an anionic surfactant (e.g., a linear alkylbenzene sulfonate and/or an alcohol ethoxylsulfate), and a nonionic surfactant (e.g., an alcohol ethoxylate). In other embodiments, the surfactant system does not contain or is substantially free of a sulfate surfactant.

The liquid formulation may further include a fragrance composition, a color care agent, a soil releasing polymer, an anti-disposition agent, a softening agent, or a combination thereof.

In a third aspect, the present invention provides a method of using the liquid composition of the present invention, preferably packed in a unit dose, for laundry cleaning or dishwashing by being brought in contact with laundry fabric or dishes. It may be used in combination with other detergent compositions.

### DETAILED DESCRIPTION OF THE INVENTION

The following description provides specific details, such as materials and dimensions, to provide a thorough understanding of the present invention. The skilled artisan, however, will appreciate that the present invention can be practiced without employing these specific details. Indeed, the present invention can be practiced in conjunction with processing, manufacturing, or fabricating techniques conventionally used in the detergent industry. Moreover, the processes below describe only steps, rather than a complete process flow, for manufacturing the aqueous surfactant system and unit dose composition containing the aqueous surfactant system according to the present invention.

As used herein, “a,” “an,” or “the” means one or more unless otherwise specified.

The term “or” can be conjunctive or disjunctive.

Open terms such as “include,” “including,” “contain,” “containing” and the like mean “comprising.”

As used herein, the terms “container”, “pouch”, “pack”, “pac”, “unit dose”, and “single dose” can be used interchangeably and can have one or two or multi-compartment (i.e., multi-chamber).

As used herein, the term “stable” means that the pac maintains its rigidity and film integrity without breakage and/or leakage.

As used herein, the terms “solvent,” “solvents,” and “solvent system,” mean a liquid or liquids used to dissolve or solvate other chemicals. In some cases, materials can also be dispersed within the solvent (i.e., Titanium Dioxide in water). In other cases, a solvent (i.e., solvent A) can initially exist as a solid and then be dissolved within solvent B, so solvent A can then act as a solvent itself (i.e., PEG 3350 in water). As used herein, the terms “solvent,” “solvents,” and “solvent system,” do not include neutralization agents, such as, e.g., triethanolamine, monoethanolamine, and sodium hydroxide.

As used herein, the term “about” includes the recited number ±10%. For example, “about 10” means 9 to 11.

As used herein, the phrase “substantially free of” means that a composition contains little no specified ingredient/component, such as less than about 1 wt %, 0.5 wt %, or 0.1 wt %, or below the detectable level of the specified ingredient. For example, the phrase “substantially free of a sulphate surfactant” refers to a liquid composition of the present invention that contains little or no sulphate surfactant.

As used herein, the “%” described in the present invention refers to the weight percentage unless otherwise indicated.

Unless stated otherwise, molecular weight of a polymer refers to weight average molecular weight.

In one aspect, the present invention provides a unit dose composition comprising a container and a liquid composition. The container may be a pouch or a pack that comprises a water-soluble or water-dispersible film, which fully encloses the liquid composition. The liquid formulation may be in the form of a solution or a suspension, although a solution is preferred. In some embodiments, the container comprises at least two compartments, with one compartment receiving the liquid composition and other compartment(s) receiving additional compositions. Each compartment may have the same or different compositions. The additional compositions may be liquid, solid, gel, or mixtures thereof.

### Container

In some embodiments, the container of the unit dose composition is made from a water-soluble or water-dispersible material that dissolves, ruptures, disperses, or disintegrates upon contact with a sufficient amount of water over a period of time, thereby releasing the composition or cleaning system contained within the container. In preferred embodiments, the water-soluble or water-dispersible container, which may be in the form of a pouch, is formed from a water soluble polymer. Non-limiting examples of suitable water soluble polymers include polyvinyl alcohol, cellulose ethers, polyethylene oxide, starch, polyvinylpyrrolidone, polyacrylamide, polyacrylonitrile, polyvinyl methyl ether-maleic anhydride, polymaleic anhydride, styrene maleic anhydride, hydroxyethylcellulose, methylcellulose, polyethylene glycol, carboxymethylcellulose, polyacrylic acid salts, alginates, acrylamide copolymers, guar gum, casein, ethylene-maleic anhydride resins, polyethyleneimine, ethyl hydroxyethylcellulose, ethyl methylcellulose, hydroxyethyl methylcellulose, film forming cellulosic polymer, polyanhydride, polysaccharide, polyalkylene oxide, cellulose, cellulose ester, cellulose amide, polyvinyl acetate, polycarboxylic acid and salt, polyaminoacid, polyamide, natural gums, polyacrylate, water-soluble acrylate copolymer, methylcellulose, carboxymethylcellulose sodium, dextrin, ethylcellulose, maltodextrin, polymethacrylate, polyvinyl alcohol copolymer, and mixtures thereof.

In some embodiments, the water-soluble or water-dispersible film material of the container can be polyvinyl alcohol, polyvinyl acetate, film forming cellulosic polymer, polyacrylic acid, polyacrylamide, polyanhydride, polysaccharide, or a mixture thereof. In some embodiments, the water-soluble or water-dispersible film material is polyvinyl alcohol or polyvinyl acetate. In a preferred embodiment, the water-soluble or water-dispersible container is made from a lower molecular weight water-soluble polyvinyl alcohol film-forming resin.

Suitable PVOH films are sold under the trade name MONOSOL® (e.g., Monosol film M8630, Monosol film M8720, Monosol film M8312, available from MonoSol LLC, Merrillville, Ind.). The preferred grade is MONOSOL® film having a weight average molecular weight range of about 55,000 to 65,000 and a number average molecular weight range of about 27,000 to 33,000. Other suitable PVOH film forming resins include those sold under trade name Solublon®, available from Aicello Corporation (e.g., Solublon® PT75, Aiichi, Japan; North American subsidiary in North Vancouver, BC, Canada).

In some embodiments, the water-soluble or water-dispersible container may further contain a cross-linking agent. In one embodiment, the cross-linking agent is boric acid or sodium borate.

In some embodiments, the water-soluble or water-dispersible container can have a protective layer between the film polymer and the composition in the container. In some embodiments, the protective layer may comprise polytetrafluoroethylene (PTFE).

The water-soluble or water-dispersible container (e.g., pouch or pack) of the present invention may be in any desirable shape and size, e.g., square, rectangular, oval, elliptoid, superelliptical, or circular shape.

The film material on the container may have a thickness of between about 50 to about 120 microns.

The water-soluble or water-dispersible container of the present invention may be prepared in any suitable way, such as via molding, casting, extruding or blowing, and is then filled using an automated filling process, as known in the prior art.

### Liquid Composition

In some embodiments, the liquid composition comprises a solvent system, an ethoxylated fatty acid, and a beneficial composition. The beneficial composition may include a surfactant system, a fragrance composition, a color care agent, a soil releasing polymer, an anti-disposition agent, a softening agent, or a combination thereof.

Solvent System

The liquid composition may comprise from about 15% to about 75%, preferably from about 25% to about 70%, and more preferably from about 30% to about 65% of all of the solvents in a solvent system, based on the total weight of the liquid composition. In some embodiments, the liquid composition comprises from about 15% to about 20%, from about 20% to about 25%, from about 25% to about 30%, from about 30% to about 35%, from about 35% to about 40%, from about 40% to about 45%, from about 45% to about 50%, from about 50% to about 55%, from about 55% to about 60%, from about 60% to about 65%, from about 65% to about 70%, and from about 70% to about 75% all of the solvents, based on the total weight of the liquid composition. The solvents in the solvent system include water and at least one non-aqueous solvent.

Non-Aqueous Solvents

Suitable non-aqueous solvents for the solvent system may include polyols, ionic liquids, glycol ethers, EO/PO block copolymers, polyethylene glycol, and mixtures thereof. The non-aqueous solvents should be miscible with water, in particularly in the presence of surfactants. Such non-aqueous solvents often, if not all, have a hydroxyl functional group.

The liquid composition may comprise from about 5% to about 60%, preferably from about 10% to about 50%, and more preferably from about 15% to about 35% of non-aqueous solvents, based on the total weight of the liquid composition. In some embodiments, the liquid composition comprises from about 5% to about 10%, from about 10% to about 20%, from about 20% to about 30%, from about 30% to about 40%, from about 40% to about 50%, and from about 50% to about 60% by weight of non-aqueous solvents, based on the total weight of the liquid composition.

Polyols

By the term “polyol”, it refers to polyhydric alcohol, which may be a linear or branched alcohol with two or more hydroxyl groups, wherein it has no more than 9 aliphatic carbon chain. Preferably, the polyol includes 3 to 8 carbon chain. More preferably, the polyol includes 3 to 6 carbon chain. The molecular weight is typically less than 500 g/mol, such as less than 400 g/mol or less than 300 g/mol.

Examples of suitable polyols include, but not limited to, propylene glycol, butylene glycol, pentylene glycol, hexylene glycol, heptylene glycol, octylene glycol, 2-methyl-1,3-propanediol, xylitol, sorbitol, mannitol, diethylene glycol, triethylene glycol, glycerol, erythritol, dulcitol, inositol, and adonitol.

The liquid compositions of the present invention may contain about 1% to about 40% of one or more polyols, preferably from about 5% to about 30%, and more preferably from about 8% to about 20%, by weight of the entire liquid formulation.

In some embodiments, the solvent system comprises propylene glycol and glycerin as non-aqueous solvents. Propylene glycol and glycerin are preferably in an amount of from about 10% to about 30%, more preferably from about 15% to about 25%, by weight of the entire formulation. In some embodiments, the solvent system comprises less propylene glycol than glycerin by weight. In some embodiments, the solvent system comprises more propylene glycol than glycerin by weight. In other embodiments, the solvent system comprises propylene glycol and glycerin in about 1:1 ratio.

In some embodiments, the polyols are present at about 1 to 5 times, preferably about 2 to 4 times, and more preferably about 2 times by weight of any other non-aqueous solvents.

Polyethylene Glycol (PEG)

In some embodiments, the solvent system comprises polyethylene glycol. As conventionally used in the art, the use of polyethylene glycol (PEG) alone, not followed by a number, refers to PEG with all possible Mw. The use of PEG with a specific number, for example, “PEG 400”, indicates that that PEG having a weight average molecular weight of about 400.

PEGs suitable for the present invention can have a weight average molecular weight ranging, for example, from about 200 to about 4000. Suitable PEGs can have a weight average molecular weight of, for example, about 200, about 300, about 400, about 500, about 600, about 700, about 800, about 900, about 1000, about 1100, about 1200, about 1300, about 1400, about 1500, about 1600, about 1700, about 1800, about 1900, about 2000, about 2100, about 2200, about 2300, about 2400, about 2500, or about 2600, about 2700, about 2800, about 2900, about 3000, about 3100, about 3200, about 3300, about 3400, about 3500, about 3600, about 3700, about 3800, about 3900, about 4000, or blends thereof. In some embodiments, the PEGs are selected from a group consisting of PEG 200, PEG 300, PEG 1000, PEG 1500, PEG 2000, PEG 2500, PEG 3350, PEG 4000, and a mixture thereof.

In some embodiments, the liquid compositions of the present invention may contain 1% to about 30% of one or more PEGs, preferably from about 2% to about 20%, more preferably from about 4% to about 18%, and most preferably from about 6% to about 12%, by weight of the entire formulation. In other embodiments, the liquid compositions may contain no or substantially no PEG.

Glycol Ethers

Examples of glycol ethers suitable for use in the present invention include, but not limited to, ethylene glycol monobutyl ether, diethylene glycol monobutyl ether, triethylene glycol monobutyl ether, ethylene glycol monopropyl ether, diethylene glycol monoethyl ether, triethylene glycol monoethyl ether, diethylene glycol monomethyl ether, and triethylene glycol monomethyl ether.

In some embodiments, the liquid compositions of the present invention may contain 1% to about 30% of one or more glycol ethers, preferably from about 2% to about 20%, more preferably from about 4% to about 18%, and most preferably from about 6% to about 12%, by weight of the entire formulation. In some embodiments, the liquid compositions of the present invention may have no or substantially no glycol ethers.

EO/PO Block Polymers

In some embodiments, the solvent system comprises EO/PO block polymers, such as those marketed under the tradename Pluronic. These materials are formed by adding blocks of ethylene oxide moieties to the ends of polypropylene glycol chains to adjust the active surface properties of the resulting block polymers.

In some embodiments, the liquid compositions of the present invention may contain about 1% to about 30% of one or more EO/PO block copolymers, preferably from about 2% to about 10%, and more preferably from about 4% to about 6% by weight of the entire formulation. In some embodiments, molecular weight of the EO/PO block copolymer is less than 3500, with the EO portion at least 60% of the EO/PO molecule, preferably greater than 70%, and most preferably greater than 80%. In some embodiments, the liquid compositions of the present invention may have no or substantially no EO/PO block copolymers.

Ionic Liquids

In some embodiments, the solvent system comprises ionic liquids. The ionic liquid may include anion and cation combinations having the formulas (I, II):

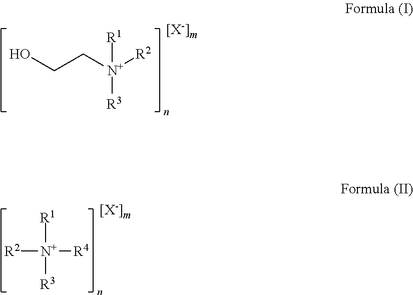

wherein R¹-R⁴ are chosen from linear or branched, substituted or unsubstituted, alkyl, aryl, alkoxyalkyl, alkylenearyl hydroxyalkyl, or haloalkyl; wherein X is an anion such as those described hereinabove; wherein m and n are chosen to provide electronic neutrality; and wherein the ionic liquids are water immiscible when at least one of R¹-R⁴ is C₁₂ or higher; or at least two of R¹-R⁴ are C₁₀ or higher; or at least three of R₁-R₄ are C₆ or higher.

In some embodiments, the liquid compositions of the present invention may contain from about 1% to about 30% one or more ionic liquids, preferably from about 2% to about 20%, more preferably from about 4% to about 18%, and most preferably from about 6% to about 12%, by weight of the entire formulation. In some embodiments, the liquid compositions of the present invention may have no or substantially no ionic liquids.

Water

Total water content in the liquid composition is the sum of added water (i.e., 100% or substantially 100% water) and water contained in other ingredients of the liquid composition. In some embodiments, the liquid composition comprises from about 5% to about 35%, preferably from about 7.5% to about 30%, more preferably from about 10% to about 25%, and even more preferably from about 15% to about 20% of total water, based on the total weight of the liquid composition.

In some embodiments, there are less water than non-aqueous solvents by weight. In other embodiments, the weight ratio of water to non-aqueous solvents is from about 3:1 to about 1:1, preferably about 14:9.

Ethoxylated Fatty Acid

In some embodiments, the ethoxylated fatty acid may be represented by the following formula (III):

R′—O—(C2H4O)n-C(O)R″ (III)

Ethoxylated fatty acid is derived from a fatty acid or a fatty acid salt reacted with a compound having a hydroxyethyl functional group. Depending on different fatty acid and different hydroxyethyl compound, the property of resulting ethoxylated fatty acid differs. In some embodiments, the ethoxylated fatty acid is a monoester. In other embodiments, the ethoxylated fatty acid is a di-ester.

In formula (III), C(O)R″ corresponds to the fatty acid (i.e., R″COOH) from which the ethoxylated fatty acid is formed. The fatty acid can be saturated, monounsaturated, di-unsaturated, or poly-unsaturated fatty acids. Examples of fatty acids suitable for preparing the ethoxylated fatty acid of the present invention include carboxylic acids with a long aliphatic tail (R″) having a total of 8 to 25 carbons, preferably 11 to 20 carbons, more preferably, 12 to 18 carbons, and even more preferably from 14 to 18 carbons. The aliphatic tail may be branched or linear, saturated or unsaturated.

In some embodiments, the fatty acid is hexanoic acid, heptanoic acid, octanoic acid, nonanoic acid, capric acid, undecanoic acid, dodecanoic acid (lauric acid), tridecanoic acid, myristic acid, pentadecanoic acid, palmitic acid, heptadecanoic acid, stearic acid, nonadecanoic acid, eicosanoic acid, heneicosanoic acid, docosanoic acid, myristoleic acid, palmitoleic acid, sapienic acid, oleic acid, elaidic acid, vaccenic acid, linoleic acid, linoelaidic acid, arachidonic acid, eicosapentaenoic acid, erucic acid, docosahexaenoic acid, or a mixture thereof. In other embodiments, the fatty acid is selected from the group consisting of arachidic acid, arachidonic acid, lauric acid, decanoic acid, caprylic acid, myristic acid, palmitic acid, palmitoleic acid, stearic acid, oleic acid, linoleic acid, and mixtures thereof. In a preferred embodiment, the fatty acid is stearic acid or lauric acid. In another preferred embodiment, the fatty acid is stearic acid.

In formula (III), R′—O—(C2H4O)n corresponds to the hydroxyethyl compound from which the ethoxylated fatty acid is formed. Examples of the compounds suitable for preparing the ethoxylated fatty acid of the present invention may be a linear or branched alcohol wherein a hydroxyl group is connected to an ethylene group. Diols with two hydroxyl groups attached to separate carbon atoms in an aliphatic chain may also be used, as long as at least one of the hydroxyl groups is connected to an ethylene group. Polyols, such as polyethylene glycol, or copolymers, such as EO/PO, may also be suitable to prepare the ethoxylated fatty acid, as long as the polymers or copolymers provide an ethoxyl functional group functional group.

In some preferred embodiments, the hydroxyethyl compound is PEG. In some embodiments, the “n” in formula (III) is from 3 to 200, from 5 to 150, or from 8 to 100. In some specific embodiments, “n” represents 8, 40, or 100, which means that the PEG has, on average, 8, 40, or 100 units of C2H4O, per unit of the formula as depicted. In some embodiments, R′ is methyl group. In other embodiments, R′ is a hydrogen.

According to some embodiments, the ethoxylated fatty acid is PEG stearate, fatty methyl ester ethoxylate, or PEG laurate. In more specific embodiments, the ethoxylated fatty acid is PEG 8 stearate, PEG 40 stearate, PEG 100 stearate, PEG 8 laurate. As known in the art, the number # in the form of “PEG # stearate” means the average unit number of the repeating ethylene oxide (EO) unit. In other words, it indicates how many moles of EO per mole of the PEG stearate. In some embodiments, the ethoxylated fatty acid is fatty methyl ester ethoxylate, wherein the EO unit may be from 5 to 30 moles, preferably from 8 to 25 moles, more preferably from 10 to 18 moles, per mole of the methyl ester ethoxylate, wherein the fatty acid contains from 10 to 22 carbons, preferably from 15 to 20 carbons, and more preferably from 16 to 18 carbons.

The ethoxylated fatty acid may be present in an amount of about 2% to about 40%, preferably from about 5% to about 20%, more preferably from about 8% to about 18%, by weight of the liquid composition.

In some embodiments, the ethoxylated fatty acid is present at about 1/10 to 1 times, about ⅕ to ½ times, or about ⅓ times, by weight of non-aqueous solvents.

Surfactant System

In some embodiments, the surfactant system in the liquid composition of the present invention includes, for example, an anionic surfactant, a nonionic surfactant, a cationic surfactant, an ampholytic surfactant, a zwitterionic surfactant, or mixtures thereof. In some embodiments, the liquid composition comprises from about 10 wt % to about 65 wt % of one or more surfactants, preferably from about 15 wt % to about 60 wt %, more preferably from about 20 wt % to about 55 wt %, and most preferably from about 30 wt % to about 50 wt %.

Examples of anionic surfactants suitable for the present invention include, but are not limited to, those surfactants that contain a long chain hydrocarbon hydrophobic group in their molecular structure and a hydrophilic group, i.e., water solubilizing group including salts such as carboxylate, sulfonate, sulfate, or phosphate groups. Suitable anionic surfactant salts include sodium, potassium, calcium, magnesium, barium, iron, ammonium and amine salts. Other suitable secondary anionic surfactants include the alkali metal, ammonium and alkanol ammonium salts of organic sulfuric reaction products having in their molecular structure an alkyl, or alkaryl group containing from 8 to 22 carbon atoms and a sulfonic or sulfuric acid ester group.

In some embodiments, the anionic surfactant is a polyethoxylated alcohol sulfate, such as those sold under the trade name CALFOAM® 303 (Pilot Chemical Company, California). Such materials, also known as alkyl ether sulfates (AES) or alkyl polyethoxylate sulfates, are those which correspond to the following formula (IV):

R′—O—(C2H4O)n-SO3M′ (IV)

wherein R′ is a C8-C20 alkyl group, n is from 1 to 20, and M′ is a salt-forming cation, preferably, R′ is C10-C18 alkyl, n is from 1 to 15, and M′ is sodium, potassium, ammonium, alkylammonium, or alkanolammonium. In another embodiment, R′ is a C12-C16 alkyl, n is from 1 to 6 and M′ is sodium. In another embodiment, the alkyl ether sulfate is sodium lauryl ether sulphate (SLES).

In some embodiments, the anionic surfactant can be linear alkylbenzene sulfonic acid (LAS) or a salt thereof, alkyl ethoxylated sulphate, alkyl propoxy sulphate, alkyl sulphate, or a mixture thereof. Linear alkylbenzenesulfonate (LAS) is a water soluble salt of a linear alkyl benzene sulfonate having between 8 and 22 carbon atoms of the linear alkyl group. The salt can be an alkali metal salt, or an ammonium, alkylammonium, or alkanolammonium salt. In one embodiment, the LAS comprises an alkali metal salt of C₁₀-C₁₆ alkyl benzene sulfonic acids, such as C₁₁-C₁₄ alkyl benzene sulfonic acids.

However, in other embodiments, the liquid compositions are substantially free of LAS. In other embodiments, the liquid compositions are substantially free of a sulfate surfactant.

Examples of nonionic surfactants suitable for the present invention include, but are not limited to, polyalkoxylated alkanolamides, polyoxyalkylene alkyl ethers, polyoxyalkylene alkylphenyl ethers, polyoxyalkylene sorbitan fatty acid esters, polyoxyalkylene sorbitol fatty acid esters, polyoxyethylene polyoxypropylene alkyl ethers, polyoxyalkylene castor oils, polyoxyalkylene alkylamines, glycerol fatty acid esters, alkylglucosamides, alkylglucosides, alkylamine oxides, amine oxide surfactants, alkoxylated fatty alcohols, or a mixture thereof. In some embodiments, the nonionic surfactant is alcohol ethoxylate (AE), alcohol propoxylate, or a mixture thereof. In other embodiments, the nonionic surfactant is AE.

The AE may be primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 moles, or from 3 to 8 moles of ethylene oxide per mole of alcohol.

Exemplary AEs are the condensation products of aliphatic C₈-C₂₀, preferably C₈-C_{16,} primary or secondary, linear or branched chain alcohols with ethylene oxide. In some embodiments, the alcohol ethoxylates contain 1 to 20, or 3 to 8 ethylene oxide groups, and may optionally be end-capped by a hydroxylated alkyl group.

In one embodiment, the AE has Formula (V):

R₂—(—O—C₂H₄—)ₘ—OH (V)

wherein R₂ is a hydrocarbyl group having 8 to 16 carbon atoms, 8 to 14 carbon atoms, 8 to 12 carbon atoms, or 8 to 10 carbon atoms; and m is from 1 to 20, or 3 to 8.

The hydrocarbyl group may be linear or branched, and saturated or unsaturated. In some embodiments, R₂ is a linear or branched C₈-C₁₆ alkyl or a linear group or branched C₈-C₁₆ alkenyl group. Preferably, R₂ is a linear or branched C₈-C₁₆ alkyl, C₈-C₁₄ alkyl, or C₈-C₁₀ alkyl group. In case (e.g., commercially available materials) where materials contain a range of carbon chain lengths, these carbon numbers represent an average. The alcohol may be derived from natural or synthetic feedstock. In one embodiment, the alcohol feedstock is coconut, containing predominantly C₁₂-C₁₄ alcohol, and oxo C₁₂-C₁₅ alcohols.

One suitable AE is Tomadol® 25-7 (available from Air Product). Other suitable AEs include Genapol® C200 (available from Clariant), which is a coco alcohol having an average degree of ethoxylation of 20.

In some embodiments, the surfactant system further comprises a zwitterionic surfactant or an amphoteric surfactant. A zwitterionic surfactant is a net-neutrally charged molecule that has positive and negative charges. Some simple amphoteric molecules can only form a net positive or negative charge depending on the pH. Other amphoteric molecules can form a net-neutral charge, depending on the pH. Examples of zwitterionic materials include betaine.

In some embodiments, the liquid composition of the present invention does not contain or is substantially free of a hygroscopic chelant, such as iron and/or manganese chelants, diethylenetriamine pentaacetate, diethylene triamine penta(methyl phosphonic acid), ethylenediamine-N,N′-disuccinic acid, ethylenediamine tetraacetate, ethylenediamine tetra(methylene phosphonic acid), hydroxyethane di(methylene phosphonic acid), 1-hydroxyethanediphosphonic acid and salts thereof, N,N-dicarboxymethyl-2-aminopentane-1,5-dioic acid and salts thereof, and 2-phosphonobutane-1,2,4-tricarboxylic acid and salts thereof.

In some embodiments, the surfactant system comprises an anionic surfactant, and a non-ionic surfactant. For example, the surfactant system comprises (1) an alcohol ethoxylsulfate (AES), (2) an alcohol ethoxylate (AE). In some embodiments, the anionic surfactant and the non-ionic surfactant are present in a weight ratio of from 1:9 to 9:1, preferably from 3:7 to 7:3, more preferable from 4:6 to 6:4. In some embodiments, the anionic surfactant and the non-ionic surfactant are present in a weight ratio of from 1:9 to 9:1, from 1:8 to 8:1, from 1:7 to 7:1, from 1:6 to 6:1, from 1:5 to 5:1, from 1:4 to 4:1, from 1:3 to 3:1, or from 1:2 to 2:1. In some embodiments, the anionic surfactant and the non-ionic surfactant are present in a weight ratio of from 2:3 to 3:2, from 2:5 to 5:2, from 3:4 to 4:3, from 3:5 to 5:3, or from 3:7 to 7:3. In some embodiments, the anionic surfactant and the non-ionic surfactant are present in a weight ratio of about 1:1.

In some embodiments, the amount of AES in the aqueous surfactant system of the present invention is selected so as to form a structured surfactant system. In some embodiments, the surfactant system contains from about 15 to about 45 wt %, about 20 to about 40 wt %, or about 25 to 35 wt % of AES, based on the total weight the surfactant system.

In some embodiments, the amount of non-ionic surfactant (e.g., AE), in the surfactant system is selected so as to form a structured surfactant system. In some embodiments, the surfactant system of the present invention comprises from about 30 to about 70 wt %, from about 40 to about 60 wt %, about 45 to about 60 wt %, from about 50 to about 60 wt %, about 45 to about 55 wt %, or about 45 to about 50 wt % of AE, based on the total weight the surfactant system.

The surfactant system of the present invention may contain a fatty acid. Suitable fatty acid may be any fatty acid having formula: R₃—C(O)OH, wherein R₃ is a C₅-C₂₁ linear or branched aliphatic group. Preferably, the R₃ is a C₁₃-C₂₁ linear or branched aliphatic group.

In some embodiments, the fatty acid is hexanoic acid, heptanoic acid, octanoic acid, nonanoic acid, capric acid, undecanoic acid, dodecanoic acid (lauric acid), tridecanoic acid, myristic acid, pentadecanoic acid, palmitic acid, heptadecanoic acid, stearic acid, nonadecanoic acid, eicosanoic acid, heneicosanoic acid, docosanoic acid, myristoleic acid, palmitoleic acid, sapienic acid, oleic acid, elaidic acid, vaccenic acid, linoleic acid, linoelaidic acid, arachidonic acid, eicosapentaenoic acid, erucic acid, docosahexaenoic acid, or a mixture thereof. In some embodiments, the fatty acid is dodecanoic acid (also known as coconut fatty acid).

In some embodiments, the amount of the fatty acid in the surfactant system is selected so as to form a structured surfactant system. In some embodiments, the surfactant system of the present invention contains from about 1 to about 20 wt %, from about 1 to about 15 wt %, from about 1 to about 10 wt %, from about 1 to about 6 wt %, or from about 1 to 4 wt % fatty acid, based on the total weight the surfactant system. In some embodiments, the surfactant system of the present invention contains from about 9 wt % of fatty acid based on the total weight the surfactant system.

Other Ingredients

In addition to a surfactant system, the beneficial composition comprises a surfactant system, a fragrance composition, a color care agent, a soil releasing polymer, an anti-disposition agent, a softening agent, or a combination thereof. It may also comprise a whitening agent, a brightening agent, a color/texture rejuvenating agent, a bleaching catalyst, a bleaching agent, a bleach activator, a buffer, a surfactant stabilizer, a neutralization agent, a builder, an enzyme, a dye (colorant), a dispersing agent, a defoamer, an anticorrosion agent, a deodorizing agent, a preservative, a bittering agent, and/or a biocidal agent.

In another aspect, the present invention provides a liquid composition which may be used in preparing a unit dose detergent pouch, wherein the pouch is made of a water dissolvable film material. The liquid composition may also be used in preparing a conventional liquid detergent container as a bulk supply liquid. The formulation of the liquid composition is the same or substantially the same as what has been described previously. Thus, details of the formulation will not be repeated.

In a further aspect, the present invention provides a method of using the liquid composition of the present invention for cleaning. For example, a liquid composition or unit dose composition of the present invention may be added to a wash liquor to which laundry is present, or to which laundry will be added. It may be used in combination with other laundry detergent compositions, such as, e.g., fabric softeners or stain removers. It may also be used in an automatic washing machine operation and added directly to the drum or to the dispenser drawer of the machine.

The unit dose composition of the present invention can be added to a wash liquor to which dishes are present, or to which dishes will be added. It may also be used in an automatic dishwashing machine operation and added directly to the drum or to the dispenser drawer of the machine.

### EXAMPLES

The following examples are illustrative and non-limiting of the compositions of the present invention. Suitable modifications and adaptations of the variety of conditions, formulations, and other parameters normally encountered in the field and which are obvious to those skilled in the art in view of this invention are within the spirit and scope of the invention.

### Example 1

### Unit Dose Compositions

As shown in Table 1, unit dose compositions were prepared by incorporating solvents, polymers, enzymes, acids, bases, and other functional materials commonly used in a finished product. The bases are added in an amount sufficient to make the pH of the composition to be in a range of from about 7.2 to about 8.2. The total water amount is the sum of added water and water from all of the other components of the compositions.

TABLE 1

| | Comparative | | | | |
|---|---|---|---|---|---|
| | Sample 1 | Formulation A | Formulation B | Formulation C | Formulation D |
| | (% wt) | (% wt) | (% wt) | (% wt) | (% wt) |
| Sodium C12-C14 | 24.4 | 24.4 | 24.4 | 24.4 | 24.4 |
| Alcohol | | | | | |
| Ethoxysulfate | | | | | |
| 3EO (AES), | | | | | |
| 60% | | | | | |
| C12-C15 | 23.1 | 23.1 | 23.1 | 23.1 | 23.1 |
| Alcohol | | | | | |
| Ethoxylate | | | | | |
| 7EO | | | | | |
| Fatty Acid | 4.0 | 4.0 | 4.0 | 4.0 | 4.0 |
| Enzymes | 2.5 | 2.5 | 2.5 | 2.5 | 2.5 |
| Bases | q.s. | q.s. | q.s. | q.s. | q.s. |
| Other | 8.9 | 8.9 | 8.9 | 8.9 | 8.9 |
| Ingredients | | | | | |
| Propylene | 8.0 | 8.0 | 8.0 | 8.0 | 8.0 |
| Glycol | | | | | |
| Glycerin | 9.7 | 9.7 | 9.7 | 9.7 | 9.7 |
| PEG 400 | 8.0 | 0 | 0 | 0 | 0 |
| PEG 8 | 0 | 8.0 | 0 | 0 | 0 |
| Stearate | | | | | |
| PEG 40 | 0 | 0 | 8.0 | 0 | 0 |
| Stearate | | | | | |
| C18 Methyl | 0 | 0 | 0 | 8.0 | 0 |
| Ester | | | | | |
| Ethoxylate | | | | | |
| 10EO (MEE) | | | | | |
| PEG 8 | 0 | 0 | 0 | 0 | 8.0 |
| Laurate | | | | | |
| Added water | 10.0 | 10.0 | 10.0 | 10.0 | 10.0 |
| Total Water | 18.2* | 18.2* | 18.2* | 18.2* | 18.2* |
| Amount* | | | | | |

### Example 2

### Comparative Cleaning Performance Test

Formulations A to D were tested for their cleaning performance, comparing to Comparative Sample 1. The wash test consisted of 2 washes in a traditional top-loaded washing machine at both 90° F. and 59° F. using all 6 stains (Grass, Chocolate Ice Cream, Grape Juice, Coffee, Dust Sebum, blood) in 120 ppm water on one fabric (woven blend). Stain Removal Indexes (SRI) were collected following the procedure per the ASTM International standard, designated as D4265 (2014), “Standard Guide for Evaluating Stain Removal Performance in Home Laundering”. The SRI values are listed in Table 2.

TABLE 2

| | | | SRI Value | | | | |
|---|---|---|---|---|---|---|---|
| Wash | | | Comparative | | | | |
| Temperature | Stain | Fabric | Sample 1 | Formulation A | Formulation B | Formulation C | Formulation D |
| 59 F. | Grass | Woven | 88.88 | 90.31 | 90.21 | 89.35 | 89.36 |
| | | Blend | | | | | |
| | Chocolate | Woven | 94.95 | 95.75 | 95.59 | 95.36 | 95.25 |
| | Ice | Blend | | | | | |
| | Cream | | | | | | |
| | Coffee | Woven | 92.19 | 92.47 | 92.65 | 92.52 | 92.13 |
| | | Blend | | | | | |
| | Grape | Woven | 91.14 | 91.43 | 91.43 | 91.94 | 91.26 |
| | Juice | Blend | | | | | |
| | Dust | Woven | 87.51 | 87.38 | 88.04 | 88.22 | 86.69 |
| | Sebum | Blend | | | | | |
| 90 F. | Blood | Woven | 91.08 | 91.23 | 91.5 | 91.6 | 90.99 |
| | | Blend | | | | | |
| | Coffee | Woven | 92.95 | 93.26 | 93.2 | 93.14 | 92.94 |
| | | Blend | | | | | |
| | Grape | Woven | 93.78 | 93.81 | 93.94 | 93.87 | 93.58 |
| | Juice | Blend | | | | | |

The SRI data indicates that the cleaning performance of the Formulations using the ethoxylated fatty acids were comparable to the reference Formulation. Furthermore, Formulations A and B (with PEG 8 and 40 Stearates, respectively) and Formulation C (with PMEE) showed a statistical improvement on cleaning certain stains versus the reference Formulation. Formulation C (with PEG 8 Laurate) also showed an improvement on certain stain removals.

### Example 3

### Unit Dose Compositions

More unit dose compositions were prepared according to the Formulations in Table 3. Furthermore, the compositions were placed into a single-chamber pac (24 grams per pac) using an Aicello Film GS-75 by following conventional unit dose preparation processes. The bases are added in an amount sufficient to make the pH of the composition to be in a range of from about 7.2 to about 8.2. The total water amount is the sum of added water and water from all of the other components of the compositions.

TABLE 3

| | Comparative | | |
|---|---|---|---|
| | Sample 2 | Formulation E | Formulation F |
| | (% wt) | (% wt) | (% wt) |
| Sodium C12-C14 | 24.0 | 24.04 | 22 |
| Alcohol | | | |
| Ethoxysulfate | | | |
| 3EO (AES), | | | |
| 60% | | | |
| C12-C15 | 23.1 | 23.1 | 21.2 |
| Alcohol | | | |
| Ethoxylate | | | |
| 7EO | | | |
| Fatty Acid | 4.0 | 4.0 | 3.7 |
| Enzymes | 2.5 | 2.5 | 2.3 |
| Bases | q.s. | q.s. | q.s. |
| Other | 8.9 | 8.9 | 8.2 |
| Ingredients | | | |
| Propylene | 8.7 | 8.7 | 8.0 |
| Glycol | | | |
| Glycerin | 8.7 | 8.7 | 8.0 |
| PEG 400 | 8.7 | 0 | 0 |
| PEG 100 | 0 | 8.7 | 16 |
| Stearate | | | |
| Added water | 10.0 | 10.0 | 9.2 |
| Total Water | 19.6* | 19.6* | 18.0* |
| Amount* | | | |

### Example 4

### Pac Rigidity Test

The pacs prepared in accordance to Example 3 were placed into a temperature controlled environment at 68° F. (20° C.), and studied at 24 hours and at 2.5 months. Pac rigidity was evaluated by measuring the width of the pacs (chambers). The decrease in the chamber width indicates the loss of pac rigidity. Specifically, the width of chamber was measured by using Ames Logic Basic Digital Comparator Model BG1110-1-04, on a column mounted indicator, model 99-0697. Width of sample was measured by placing pac under digital indicator, after scale was zeroed.

The Pac Rigidity Test results are shown in Table 4. Formulations E and F (with PEG 100 stearate) clearly showed improvement of rigidity over the comparative sample. The pac rigidity improves with the use of more ethoxylated fatty acid in the Formulation. (Formulation F). Furthermore, the pacs having the ethoxylated fatty acid in the Formulation exhibited a significant long-term improvement in the pac rigidity.

Width of chamber in inches

| | 24 hr at 20 C.* | 2.5 months at 20 C.* |
|---|---|---|
| Comparative | 0.71 | 0.67 |
| Sample 2 | | |
| Formulation E | 0.78 | 0.78 |
| Formulation F | 0.82 | 0.81 |

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A unit dose composition, comprising:
(a) a container formed from a water-soluble or water-dispersible film material; and
(b) a liquid composition comprising:
(i) a solvent system comprising water and at least one non-aqueous solvent, wherein said solvent system totals from about 15% to about 75% by weight of the liquid composition;
(ii) an ethoxylated fatty acid in an amount of about 2% to about 40% by weight of the liquid composition; and
(iii) a beneficial composition;
wherein the container entraps the liquid composition.

2. The composition of claim 1, wherein the ethoxylated fatty acid is in an amount of about 8% to about 18% by weight of the liquid composition.

3. The composition of claim 1, wherein the ethoxylated fatty acid is an ester of a fatty acid having a C8 to C25 length of aliphatic carbon chain.

4. The composition of claim 3, wherein the fatty acid is stearic acid.

5. The composition of claim 3, wherein the fatty acid is lauric acid.

6. The composition of claim 1, wherein the ethoxylated fatty acid is derived from a polyol reacting with a fatty acid.

7. The composition of claim 6, wherein the polyol is a PEG.

8. The composition of claim 1, wherein the ethoxylated fatty acid is a PEG stearate, a PEG laurate, or a methyl ester ethoxylate.

9. The composition of claim 8, wherein the ethoxylated fatty acid is a PEG 100 stearate.

10. The composition of claim 1, wherein the solvent system totals from about 30% to about 65% by weight of the liquid composition.

11. The composition of claim 1, wherein water is in an amount of about 10% to about 30% by weight of the liquid composition.

12. The composition of claim 1, wherein the at least one non-aqueous solvent comprises glycerin and a glycol.

13. The composition of claim 12, wherein the glycol is propylene glycol.

14. The composition of claim 1 further comprising an additional polyol, an enzyme, or a combination thereof.

15. The composition of claim 14, wherein the additional polyol is selected from a group consisting of PEG 200, PEG 300, PEG 1000, PEG 1500, PEG 2000, PEG 2500, PEG 3350, PEG 4000, and a blend thereof.

16. The composition of claim 15, wherein the additional polyol is PEG 400.

17. The composition of claim 1, wherein the beneficial composition comprises a surfactant system, a fragrance composition, a color care agent, a polymer release agent, an anti-disposition agent, a softening agent, or a combination thereof.

18. The composition of claim 17, wherein the surfactant system comprises an anionic surfactant, a nonionic surfactant, a cationic surfactant, an ampholytic surfactant, a zwitterionic surfactant, or a mixture thereof.

19. The composition of claim 18, wherein the surfactant system comprises (a) an alcohol ethoxylsulfate (AES); and (b) an alcohol ethoxylate (AE).

20. The composition of claim 19, wherein the surfactant system further comprising a fatty acid.
